(19) United States
(12) Patent Application Publication
(10) Pub. No.: US 2025/0214722 A1
(43) Pub. Date: Jul. 3, 2025

(54) UNMANNED FIXED WING VERTICAL TAKE-OFF AND LANDING AIRCRAFT

(71) Applicant: AUSTIN AERONAUTICS PTY LTD, Holland Park West (AU)

(72) Inventor: Daniel AUSTIN, Holland Park West (AU)

(73) Assignee: AUSTIN AERONAUTICS PTY LTD, Holland Park West (AU)

(21) Appl. No.: 18/852,566

(22) PCT Filed: Mar. 31, 2023
(86) PCT No.: PCT/AU2023/050247

§ 371 Date: Sep. 30, 2024

(30) Foreign Application Priority Data
Mar. 31, 2022 (AU) 2022900830

(51) Int. Cl. B64U 10/20; B64C 3/40; B64C 29/00; B64D 17/62; B64U 30/10; B64U 30/29

(52) U.S. Cl. CPC B64U 10/20; B64C 3/40; B64C 29/0033; B64U 30/10; B64U 30/29; B64D 17/62

(57) ABSTRACT

An unmanned fixed wing vertical take-off and landing aircraft, including: an elongate fuselage defining a longitudinal axis, the fuselage having a nose and a tail; a pair of rearward swept fixed wings, each wing having a root end respectively attached at an opposite side of a middle portion of the fuselage; three pairs of independent thrust units where at least a first pair of thrust units is positioned at the nose and tail of the fuselage and each of the fixed wings respectively includes at least a pair of thrust units; where the three pairs of independent thrust units are arranged at aerodynamically appropriate locations to enable vertical take-off and landing of the aircraft and to avoid a flight compromise when at least one of the three pairs of thrust units fails to operate.

### TECHNICAL FIELD

The present invention relates to an improved design for an unmanned fixed wing vertical take-off and landing (VTOL) aircraft.

### BACKGROUND

Any references to methods, apparatus or documents of the prior art are not to be taken as constituting any evidence or admission that they formed, or form part of the common general knowledge.

Autonomous drones, also referred to as unmanned aerial vehicles (UAVs) and remotely piloted aircraft (RPA) that can be used for various applications including but not limited to delivery of agricultural services (livestock monitoring, property inspection, crop management, spraying effectiveness); essential services (critical medicine delivery for remote regions); surveying and assisting with maritime and coastal services.

Inspite of rapid developments in UAV related technologies, it is desirable to have UAVs that are stable and capable of high-speed cruising to enable quicker response times during various operations. It is also design these UAVs that have improved redundancy capabilities. Redundancy measures usually take the form of a backup or fail safe, or measures that seek to improve the actual system performance, like is common in GNSS (Global Navigation Satellite System) receivers and multi-threaded computer processing. However, it is desirable to improve current UAV designs to provide ultimate reliability and redundancy covering all flight scenarios so that UAV is capable of handling degraded propulsion and aerodynamics.

### SUMMARY OF INVENTION

In an aspect, the invention provides an unmanned fixed wing vertical take-off and landing aircraft, comprising:
an elongated fuselage defining a longitudinal axis, the fuselage having a nose and a tail;
a pair of rearward swept fixed wings, each wing having a root end respectively attached at an opposite side of a middle portion of the fuselage;
three pairs of independent thrust units wherein at least a first pair of thrust units is positioned at the nose and tail of the fuselage and each of said fixed wings respectively comprises at least a pair of thrust units;
wherein the three pairs of independent thrust units are arranged at aerodynamically appropriate locations to enable vertical take-off and landing of the aircraft and to avoid a flight compromise when at least one of the three pairs of thrust units fails to operate.

In an embodiment, the thrust units in each pair of said thrust units are arranged at diametrically opposite locations.

In an embodiment, the three pairs of thrust units are arranged in a hexagonal configuration balanced about a center of gravity located in the middle portion of the fuselage.

Preferably, a first plurality of at least three thrust units are mounted on the nose portion of the fuselage and each fixed wing respectively to form a forward V-shaped configuration and a second plurality of at least three thrust units are mounted on the tail portion of the fuselage and each fixed wing respectively to form a rearward V-shaped configuration.

In an embodiment, one or more of the thrust units comprises rotors mounted on a rotary axle mechanism.

In an embodiment, each fixed wing comprises a forwardly positioned thrust unit and a rearwardly positioned thrust unit such that at least the forwardly positioned thrust unit comprises said rotors mounted on the rotary axle mechanism, the axle mechanism being arranged to tilt between the vertical direction and the horizontal direction.

In an embodiment, each fixed wing comprises a forwardly positioned thrust unit and a rearwardly positioned thrust unit wherein each thrust unit comprises oppositely arranged rotors mounted on corresponding rotary axle mechanisms that extend in upwardly and downwardly directions respectively.

In an embodiment, the forwardly positioned thrust unit and the rearwardly positioned thrust unit are mounted on a mounting member extending across said fixed wing.

In another embodiment, each fixed wing comprises a forwardly positioned thrust unit and a rearwardly positioned thrust unit such that at least the forwardly positioned thrust unit comprises said rotors mounted on the rotary axle mechanism, the axle mechanism being arranged to tilt between the vertical direction and the horizontal direction.

In an embodiment, the rearwardly positioned thrust unit comprises rotors mounted on fixed rotary axle mechanism that does not undergo tilting.

In an embodiment, the tail portion of the fuselage is connected to horizontal stabilizers and a vertical stabilizer such that the thrust unit located on the tail portion is mounted on the vertical stabilizer.

In an embodiment, each of the fixed wings and the vertical and horizontal stabilizers comprises aircraft flight control surfaces and wherein each control surface is divided into two Independent sub-surfaces such that each sub-surface for any of the control surfaces is actuated by respective independently operable actuators for effecting independent angular movement about a hinge axis for each subsurface.

In an embodiment, the aircraft further comprises an avionic control system comprising:
a first plurality of electro-mechanical devices to actuate the independently operable actuators for the first subsurface for each of the flight control surfaces; and
a second plurality of electro-mechanical devices to actuate the independently operable actuators for the second subsurface for each of the flight control surfaces:

In an embodiment, each fixed wing comprises at least one primary wing control surface (alleron) to control aircraft movement along the roll axis wherein each primary wing control surface comprises two independently movable sub-surfaces actuated by respective independent primary wing control actuators.

In an embodiment, the control system is arranged to effect actuated movement of one of the sub-surfaces for each of said control surfaces for counteracting the effect of failure of the other of said sub-surfaces for said each control surface in response to receiving input indicative of failure of the other of said sub-surfaces for said each control surface.

In an embodiment, each fixed wing further comprises at least one secondary wing control surface (flap) to control lift and drag of the aircraft wherein each secondary wing control surface comprises two independently movable sub-surfaces actuated by respective independent secondary wing control actuators.

In an embodiment, each horizontal stabilizer comprises a primary horizontal stabilizer control surface to control aircraft movement about the pitch axis wherein each primary horizontal stabilizer control surface comprises two independently movable sub-surfaces actuated by respective independent primary horizontal stabilizer control actuators.

In an embodiment, the vertical stabilizer comprises a primary vertical stabilizer control surface to control aircraft movement about the yaw axis wherein each primary vertical stabilizer control surface comprises two independently movable sub-surfaces actuated by respective independent primary horizontal stabilizer control actuators.

In an embodiment, an aft section of the fuselage comprises a parachute deployment system to enable deployment of a parachute in a rearward and downward direction during substantial failure of the thrust units and/or control surfaces.

In an embodiment, central section of the fuselage comprises a height with an internal volume defined by a top wall, side walls and a bottom wall such that height of the fuselage in substantially constant in the central section and wherein the height gradually decreases from the central section towards the nose and tail respectively due to tapering of the floor and side walls towards the nose and tail respectively.

In an embodiment, the parachute deployment system is arranged to deploy the parachute from an opening provided in the tapering floor section tapering towards the tall to allow the parachute to be unfurled out of a gap between the horizontal stabilizers of the fuselage.

In an embodiment, the parachute deployment system comprises an enclosure to enclose a parachute with a trigger mechanism coupled with the enclosure to trigger ejection of the parachute into deployed state, the trigger mechanism being operatively linked to a controller for controlling actuation of the trigger mechanism.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a first top view of an aircraft 100 showing hexagonal arrangement of thrust units 150.

FIG. 2 is a second top view of the aircraft 100.

FIG. 3 is a side view of the aircraft 100 in a vertical flight mode.

FIG. 4 is a frontal perspective view of the aircraft 100 in horizontal flight mode.

FIG. 5 is a side view of the aircraft with a internal parachute deployment system 170.

FIG. 6 is a first top view of an aircraft 200 (second embodiment) showing hexagonal arrangement of thrust units 250.

FIG. 7 is a second top view of the aircraft 200.

FIG. 8 is a side view of the aircraft 200 in a vertical flight mode.

FIG. 9 is a frontal perspective view of the aircraft 200 in horizontal flight mode.

FIG. 10 is a side view of the aircraft 200 with a internal parachute deployment system 170.

FIG. 11 is an enlarged view of the rudder control surface 104.

FIG. 12 is an enlarged view of the elevator control surfaces 102.

FIG. 13 is an enlarged view of the left fixed wing 120 showing the left alerion 160A.

FIG. 14 is a schematic diagram of the control system 500 control the primary and secondary control surfaces of the aircraft (100 or 200).

### DETAILED DESCRIPTION OF PREFERRED EMBODIMENTS

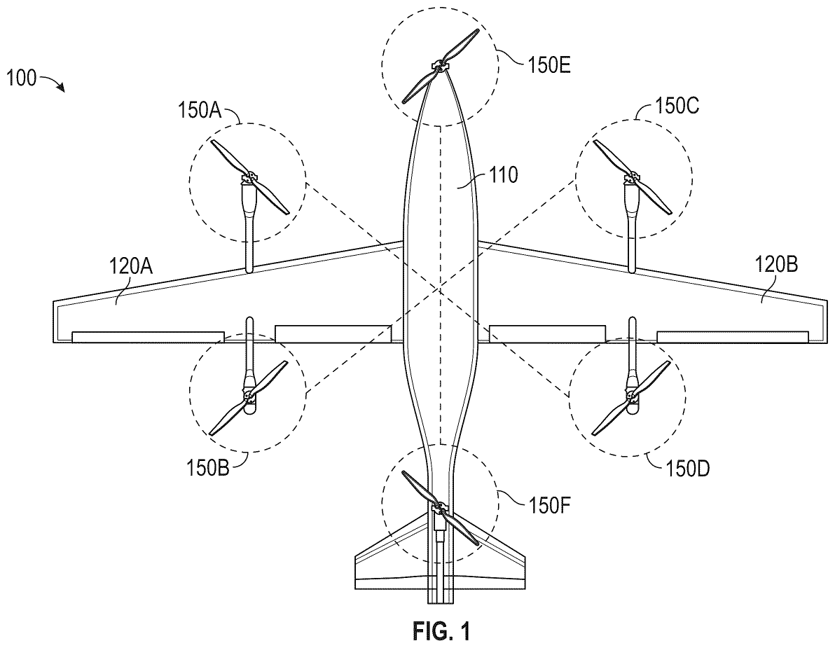

FIGS. 1 to 5 illustrate an unmanned fixed wing vertical take-off and landing aircraft 100 in accordance with a preferred embodiment. The aircraft is designated as a whole with the reference symbol 100 and comprises an elongate fuselage 110 defining a longitudinal axis. The fuselage 110 extends between a nose 112 and a tail 114.

The aircraft 100 comprises a fixed wing design with a pair of rearward swept wings 120A and 120B (generally denoted by reference numeral 120). The wings 120A and 120B are attached on opposite sides of a middle portion 116 of the fuselage 110 at their respective root ends 122.

As will be evident from the foregoing sections, the aircraft 1000 is provided with three pairs of independent thrust units, each thrust unit 150 comprising a rotor mounted on a rotary axle mechanism, denoted by 150A, 150B, 150C, 150D, 150E and 150F (thrust units being generally denoted by the reference numeral 150) and arranged at aerodynamically appropriate locations (as explained in detail in further sections) to enable vertical take-off and landing of the aircraft and to avoid a flight compromise when at least one of the three pairs of thrust units falls to operate.

Each fixed wing 120 is provided with a first and second pairs of thrust units 150. Specifically fixed wing 120A includes a forwardly positioned thrust unit 150A and a rearwardly positioned thrust unit 150B. Similarly, the fixed wing 120B includes a forwardly positioned thrust unit 150C and a rearwardly positioned thrust unit 150D. The third pair of thrust units 150E and 150F are located at the nose 112 and tall 114. As is evident from FIG. 1, the thrust units 150 in each pair (150A, 150B; 150C, 150D; 150E, 150F) are located at diametrically opposite locations. Moreover, the six thrust units 150 are generally arranged in a hexagonal configuration balanced about a centre of gravity located in the middle portion 116 of the fuselage 110. Due to the hexagonal motor configuration in the hover flight condition, if any one thrust unit 150 falls, the aircraft 100 can still maintain stability and flight through the compensation of the other 5 motors in the hexagonal configuration. As is evident from FIG. 1, thrust units 150E, 150A and 150C are mounted on the nose portion 112 of the fuselage 110 and each fixed wing 120 respectively to form a forward V-shaped configuration. Similarly, thrust units 150F, 150B and 150D are mounted on the tall portion 114 of the fuselage 110 and each fixed wing 120 respectively to form a rearward V-shaped configuration. The forward and rearward V-shaped hexagonal configuration form a part of the hexagonal arrangement which assists with maintaining stability if any one of the six thrust units 150 fail during flight.

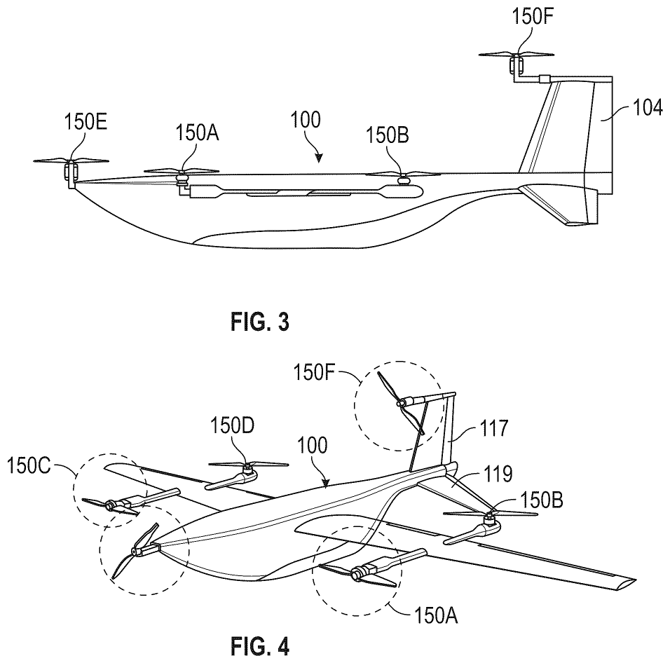

Referring to FIGS. 3 and 4, the aircraft 100 is shown in a vertical lifting operation and forward flying configuration respectively. The switching between vertical and horizontal motion is made possible by providing a tilting mechanism for the thrust units 150. Specifically, the thrust units 150 comprise rotors mounted on a rotary axle mechanism, the axle mechanism being arranged to tilt between a vertical direction and a horizontal direction. In a vertical flight mode, all of the thrust units are tilted into a vertical position to lift the aircraft 100 best shown in FIG. 3. Referring to FIG. 4, thrust units 150E, 150A, 150C and 150F tilt into a substantially horizontal position to enable the aircraft to fly in a forward flying direction. In the forward flight condition (FIG. 4), the two front wing thrust units 150A and 150C and/or the nose and rear tail thrust units 150E and 150F can be used to produce thrust to sustain forward flight. If a single thrust unit among these four thrust units falls in the forward flight configuration, the other forward thrust units can produce sufficient thrust to continue normal forward flight operations.

It is also important to note that the rear thrust unit 150F is mounted on a vertical stabilizer 117 that is fixed to the fuselage 110. The tail portion 114 also includes horizontal stabilizers 119 on either side of the vertical stabiliser. Advantageously, each of the fixed wings 120 and the vertical and horizontal stabilizers 117 and 119 comprises aircraft flight control surfaces whereby each control surface is divided into two independent sub-surfaces such that each sub-surface for any of the control surfaces is actuated by respective independently operable actuators.

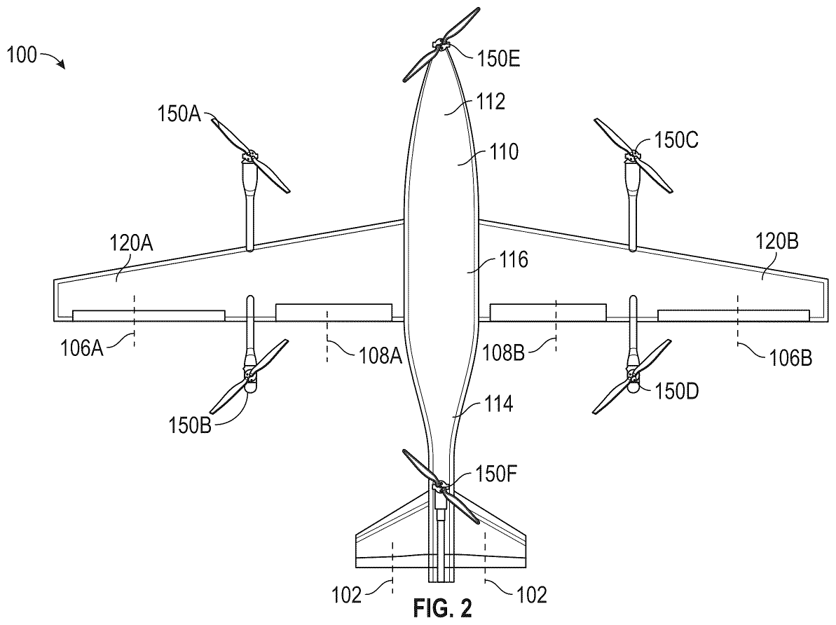

In the illustrated embodiment of FIG. 2, the aircraft 100 includes a pair of elevators 102, a rudder 104, and a pair of allerons 106A and 106B, which are the primary flight control surfaces, and a plurality of flaps 108 which are the secondary flight control surfaces. In some embodiments, additional secondary control surfaces such as slats and spoilers (not shown) may also be provided. The primary flight control surfaces 102-106 control aircraft movements about the aircraft pitch, yaw, and roll axes. Specifically, the elevators 102 are used to control aircraft movement about the pitch axis, the rudder 104 is used to control aircraft movement about the yaw axis, and the ailerons 106 control aircraft movement about the roll axis. It is noted, however, that aircraft movement about the yaw axis can also be achieved either by banking the aircraft or by varying the thrust levels from the thrust units on opposing sides of the aircraft 100.

The secondary control surfaces 108 influence the lift and drag of the aircraft 100. For example, during aircraft take-off and landing operations, when increased lift is desirable, the flaps 108 may be moved from retracted positions to extended positions. In the extended position, the flaps 108 increase both lift and drag, and enable the aircraft 100 to descend more steeply for a given airspeed, and also enable the aircraft 100 get airborne over a shorter distance.

The flight control surfaces 102-108 are moved between retracted and extended positions via a flight control surface actuation system. The flight control surface actuation system 120 includes a plurality of primary flight control surface actuators. As discussed earlier, each control surface described herein effectively consists of two sub-surfaces whereby each sub-surface is actuated by an independent actuator (not shown). These independent actuators may take the form of being elevator actuators, rudder actuators, and alleron actuators, a plurality of secondary control surface actuators, which include flap actuators. All flight control surfaces (Left Aileron, Right Aileron, Rudder, Left Elevator, Right Elevator, Left Flap, Right Flap) are split such that half the area of each flight control forms a separate control surface (sub-surface). Each control sub-surface is controlled by a separate actuator. In the event of an actuator failure, only half of the area of the flight control surface will be affected. This allows the other control surfaces to be able to counteract a hard over failure in the event of a misfunctioning control surface.

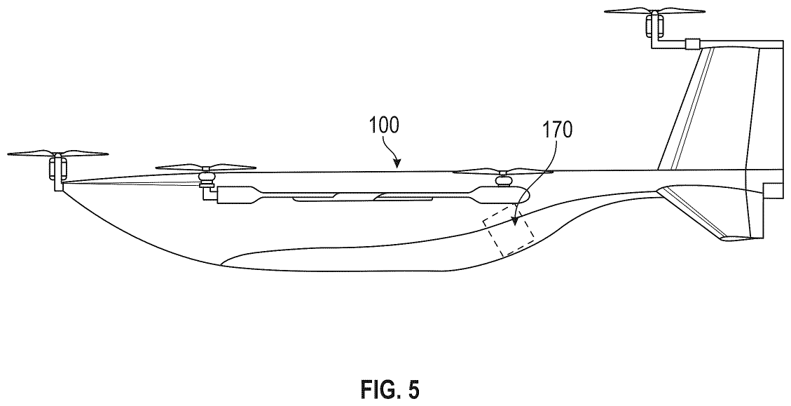

Referring to FIG. 5, the aircraft 100 also includes a parachute deployment system 170 to enable deployment of a parachute in a rearward and downward direction during substantial failure of the thrust units 150 and/or control surfaces. As shown clearly in the accompanying drawings, the fuselage 110 comprises a height with an internal volume defined by a top wall, side walls and a bottom wall such that height of the fuselage in substantially constant in the central section 116 and wherein the height gradually decreases from the central section 116 towards the nose 112 and tall 114 respectively due to tapering of the floor and side walls towards the nose and tail respectively thereby giving the fuselage 110 a streamlined configuration.

Importantly, the parachute deployment system 170 is arranged to deploy the parachute from an opening provided in the tapering floor section tapering towards the tall 114 to allow the parachute to be unfurled out of a gap between the horizontal stabilizers 119 of the fuselage 110. The configuration of the parachute system is not limiting and one embodiment, a parachute system supplied by Fruity Chutes may be modified for use. In at least one embodiment, the parachute deployment system 170 may include an enclosure to enclose a compressed parachute. The parachute deployment system may include a trigger mechanism coupled with the enclosure to trigger ejection of the parachute into a deployed state. The trigger mechanism may be operatively linked to a controller such as a servo for controlling actuation of the trigger mechanism in an emergency when other flight control systems fall. Upon triggering, the parachute can be deployed out of the enclosure through the sloped floor wall to direct the parachute in a rearward direction to allow the parachute to extend out from in between the horizontal stabilizers in an upward direction.

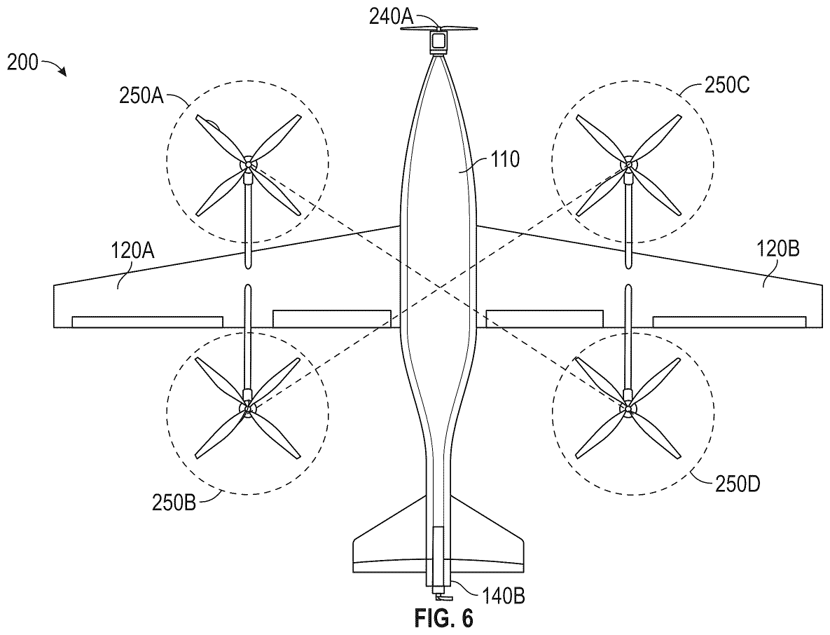

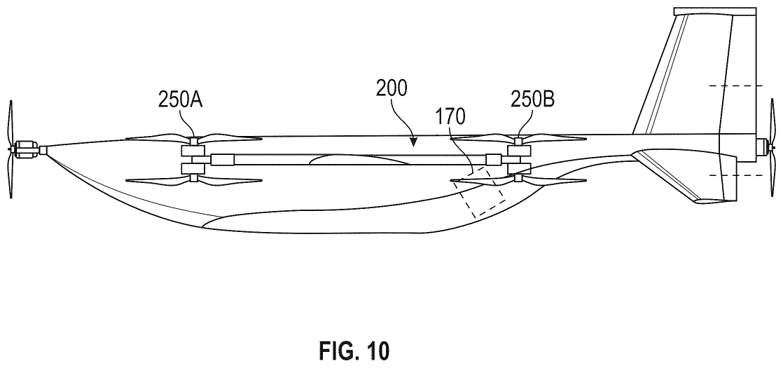

We now refer to FIGS. 6 to 10 which denote a second preferred embodiment of the aircraft 200. Like reference numerals denote like features which have been previously described in the earlier sections. As a result, the working explanation has not been repeated for the aerial vehicle 200. As evident from the Figures, the main difference between the second aircraft 200 and the previously described aerial vehicle 100 relates to the configuration of the thrust units 250.

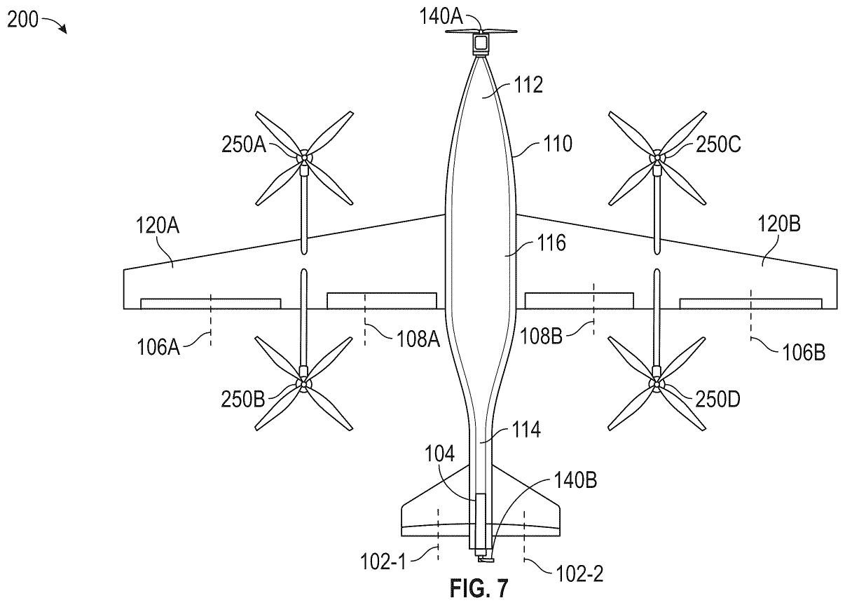

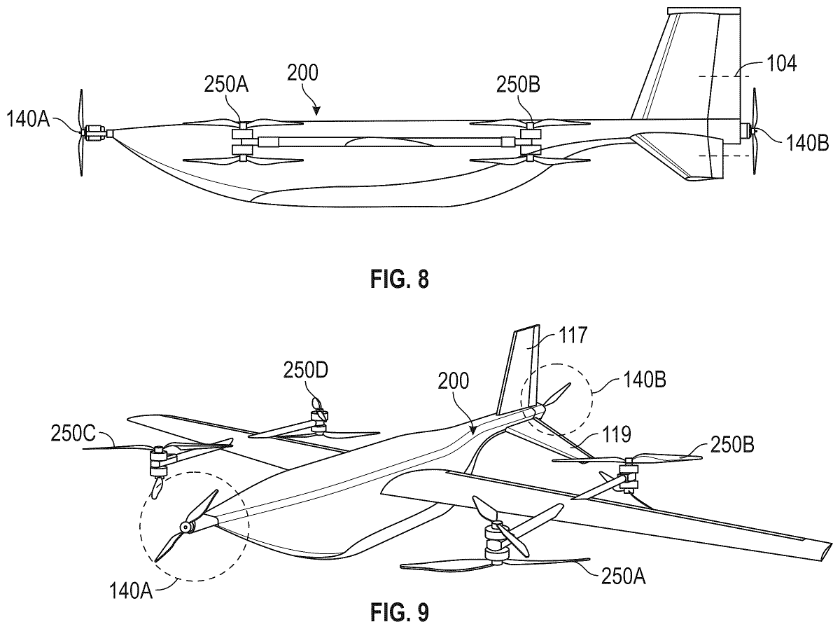

Referring to FIGS. 8 and 9, the aircraft 200 is shown in a vertical lifting operation and forward flying configuration respectively. The switching between vertical and horizontal motion is made possible by providing dual thrust units 250A, 250B, 250C and 250D. Each fixed wing 120A and 120B comprises a forwardly positioned thrust unit (250A and 250C respectively) and a rearwardly positioned thrust unit (250B and 250D respectively). Referring to FIGS. 8 and 9, each thrust unit on the fixed wings (120A or 120B) comprises oppositely arranged rotors mounted on corresponding rotary axle mechanisms that extend in upwardly and downwardly directions respectively. It is important to appreciate that each thrust unit 250 comprises to independent rotor mechanisms to avoid failure of both the upward and downwardly oriented rotor in the same thrust unit 250. Unlike the previously described embodiment, a dedicated tilting mechanism for the forwardly positioned fixed wing thrust units 250A and 250C. The configuration of the fixed wing thrust units 250 may be understood to define a Octo-Quad configuration with a total of eight rotor units being provided in the configuration shown in FIG. 7. In the hover flight condition, if the rotor mechanism (or motor) fails, the aircraft can still maintain stability and flight through the compensation of the other 7 motors in the Octo-Quad configuration.

Each pair of the thrust units (250A, 250B or 250C, 250D) for the fixed wing 120 is mounted on a mounting member 255 extending across said fixed wing 120. The shape and configuration of the mounting member 255 is not limited to having a tubular shape. The only limitation is that the forwardly located thrust units 250A and 250C are located in a forwardly spaced away location from the forwardly edge of the fixed wing 120. Similarly, the mounting member 255 also allows the rearwardly located thrust units 250B and 250D to be positioned in a rearwardly spaced away location from the rearwardly edge of the fixed wing 120.

In the illustrated embodiment of FIGS. 2 and 7, the aircrafts 100 and 200 include a pair of elevators 102, a rudder 104, and a pair of allerons 106A and 106B, which are the primary flight control surfaces, and a plurality of flaps 108 which are the secondary flight control surfaces. The primary flight control surfaces 102-106 control aircraft movements about the aircraft pitch, yaw, and roll axes. Specifically, the elevators 102 are used to control aircraft movement about the pitch axis, the rudder 104 is used to control aircraft movement about the yaw axis, and the allerons 106 control aircraft movement about the roll axis. It is noted, however, that aircraft movement about the yaw axis can also be achieved either by banking the aircraft 100 or 200 or by varying the thrust levels from the thrust units on opposing sides of the aircraft 100.

The secondary control surfaces 108 influence the lift and drag of the aircraft 100. For example, during aircraft take-off and landing operations, when increased lift is desirable, the flaps 108 may be moved from retracted positions to extended positions. In the extended position, the flaps 108 increase both lift and drag, and enable the aircraft 100 to descend more steeply for a given airspeed, and also enable the aircraft 100 get airborne over a shorter distance.

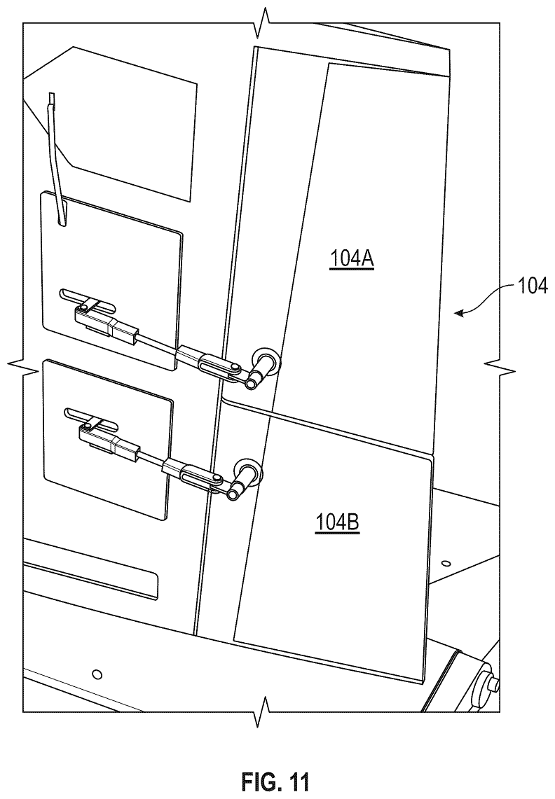

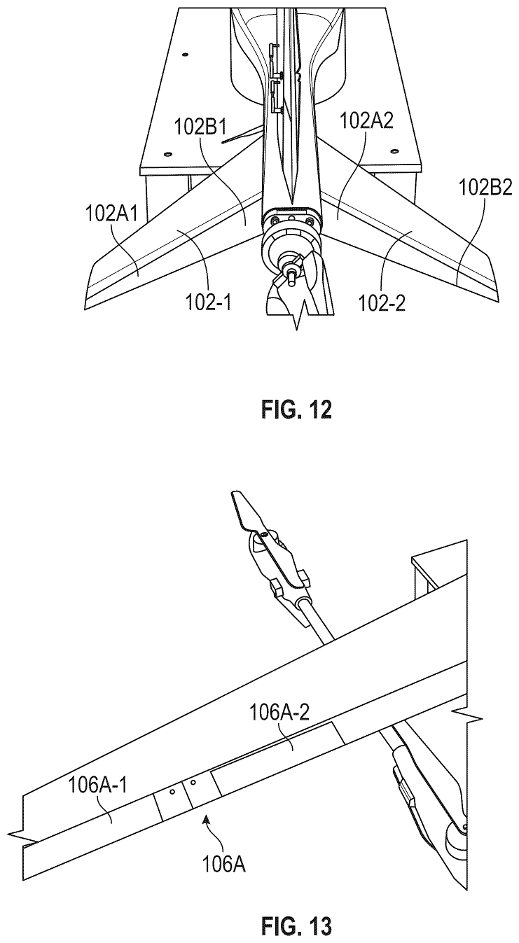

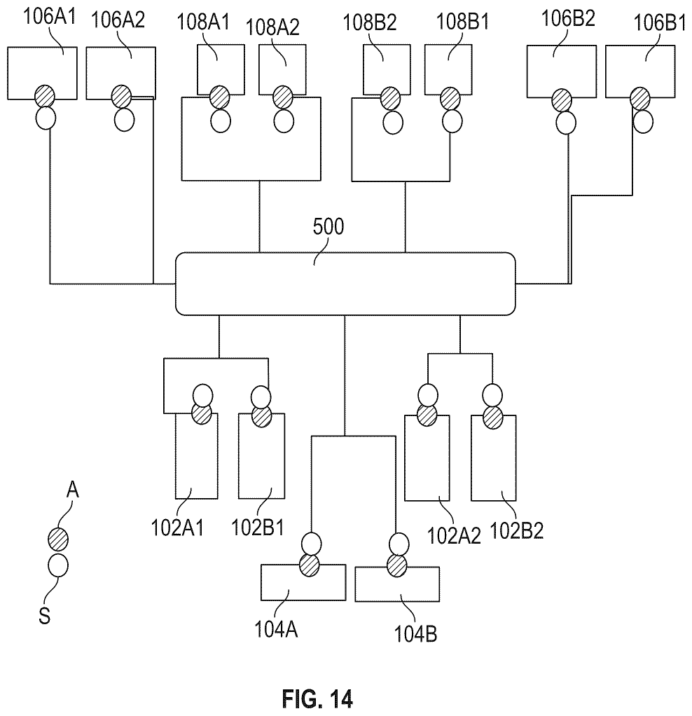

The flight control surfaces 102-108 are moved between retracted and extended positions via a flight control surface actuation system. The flight control surface actuation system 120 includes a plurality of primary flight control surface actuators. As discussed earlier, each control surface described herein effectively consists of two sub-surfaces whereby each sub-surface is actuated by an independent actuator. FIGS. 11 to 14 Illustrate clearly that each of the control surfaces 102, 104 and 106 comprise independently actuated sub-surfaces that use independent actuators. At least the primary flight control surfaces (Left Aileron, Right Aileron, Rudder, Left Elevator, Right Elevator) and in some optional embodiments the secondary control surfaces (Left Flap and Right Flap) are split such that half the area of each flight control forms a separate control surface (sub-surface). Each control sub-surface is controlled by a separate actuator (denoted by A in FIG. 14). As a result, in the event of an actuator failure, only half of the area of the flight control surface will be affected. This allows the other control sub-surface to be able to counteract a hard over failure in the event of a misfunctioning control sub-surface. As shown in FIG. 14, the left aileron 106A is divided into independently actuated sub-surfaces 106A1 and 106A2. The right aileron 106B is divided into independently actuated sub-surfaces 106B1 and 106B2. The left elevator 102-1 is divided into independently actuated sub-surfaces 102A1 and 102A2. The right elevator 102-2 is divided into independently actuated sub-surfaces 106B1 and 106B2. The rudder 104 is also divided into independently actuated sub-surfaces 104A and 104B shown in FIGS. 11 and 14. In FIG. 14, the secondary control surfaces mainly the left flap 108A and the right flap 108B are also divided into independently sub-surfaces. The left flap 108A is divided into independently actuated sub-surface 108A1 and 108A2. The right flap 108B is also divided into independently actuated sub-surface 108B1 and 108B2.

The provision of dividing each control surface into two independently controlled sub-surfaces can present advantages in several scenarios. For example, in one exemplary scenario, the aerial vehicle 100 or 200 may be undertaking forward flight at 35 m/s without any weather or external impacts to the vehicle. During such a flight, one of the control sub-surfaces 106A1 (See FIG. 13) undergoes failure due to a mechanical servo mechanism failure. (Gears binding or electrical fault). The avionics control system denoted by 500 in FIG. 14 would recognise the failure by feedback to the autopilot system through a CAN based electronic control system. In FIG. 14, the control system 500 is connected with each of the independently operable actuators (denoted by A). Each control sub-surface is also arranged to provide positioned related feedback information via sensing modules S. The affected control sub-surface 160A1'failure including its state and positional information would be received via a CANBUS system. If this affected control sub-surface 106A1 is any position other than 0 degrees (neutral) the partner panel for that surface would initially react to create a nulled effect to the control input through the implementation of a custom script via the autopilot system. In the forward flight any position of the subsurface 106A1 other than 0 would induce roll, pitch or yaw depending on the malfunctioning surface. In this scenario, the left aileron control surface 106 undergoes a malfunction (the left outermost sub-surface panel 106A1 fails in the up position), this would cause a left roll or left wing 120A to drop. In the absence of two independently actuated sub-surfaces 106A1 and 106A2 forming the control surface 106A (left aileron), the Autopilot system of a conventional VTOL vehicle would sense the left roll and attempt to counteract the roll with a right input, but in doing so it would use all aerodynamic travel (of the right aileron 106B on the right wing 120B) just to counteract and maintain balanced flight (straight and level) which at best is only able to avoid an immediate crash of the VTOL. A conventional VTOL is unable to successfully manoeuvre in roll to a safe landing area.

Unlike conventional VTOL aircraft, in the presently described VTOL vehicle 100 and 200 that incorporates two independent subsurfaces for each primary control surface (at least), when one of the subsurface panels (say 106A1) in each control surface (say 106A) fails, the avionics control system immediately counteracts the other subsurface panel (say 106A2) to immediately counteract the roll anomaly. In this example it would be split one panel up (being the failed panel 106A1) and one panel down (106A2) being the serviceable panel. The resultant outcome is now a drag increase on that left wingtip 120A but importantly a nulled roll. The right wing 120B is still able to function with full range of motion to induce roll inputs that would produce a degraded but still functional roll and allow vehicle control. Once roll is nulled during the malfunction the vehicle will have a resultant cruise speed reduction due to drag and the right aileron control panels (106B1 and 106B2) will return to the neutral position. The drag will induce a minor yaw moment which can be countered using the rudder.

The provision of the independently actuated sub-surface panels for each control surface, the left aileron would fail, the pilot or autopilot would counteract and the vehicle would be limited to flying straight ahead, and likely have to crash land ahead with no ability to roll control other than rudder (but this is very difficult to achieve). The secondary effect of yaw is roll but it is very unbalanced and would be extremely hard to execute in this scenario.

In another exemplary scenario, the right inboard elevator sub-surface panel 102A2 fails in the 50% down position. As per the roll example this failure is now in the pitch axis. The initial result is an uncommanded pitch nose down which the autopilot will try and compensate for by pitching the left elevator panels 102A1 and 102B1 to the opposite direction. In conventional VTOL aircraft, Under normal circumstances where the elevator control surface is a single surface (one panel only), the failure of such a panel would result in vehicle control being lost. Using the split control surface arrangement for the left and right elevator control surfaces 102, when one of the subsurface panels fails (say 102A2), the other subsurface panel (say 102B2) for the elevator control surfaces 102-2 counteracts the affect of the failed subsurface panel 102A2 through the avionics control system thereby counteracting the pitching moment. Simultaneously the right outboard elevator panel 102B2 is able to null the right half pitch anomaly by fixing in the upper region and inducing drag. Once pitch is nulled the vehicle will have a resultant cruise speed reduction due to drag and the left elevator panel will return to the neutral position. The drag will induce a minor yaw moment which can be countered using the rudder. The result in such a scenario is a vehicle that still operates in pitch with a degraded action (lower degrees per sec). As the vehicle is positioned for landing, one half of the elevator being functional, there would be a slight roll tendency to occur however this will be managed by the aileron and rudder in compensation. Eg pitch up would have a slight toll left therefore the system would pitch up whilst rolling right (to produce a resultant balanced pitch up action with no visible roll).

This control system that counteracts the failure of one subsurface panel by actuating the other subsurface panel into a counteracting position is intended to remove the pitch, roll or yaw anomaly. The electro mechanical inputs are split and isolated and so too are the aerodynamic inputs so if there was damage to a wing tip or a tail due to Foreign object damage there is a chance the system can still function as it is physically independent.

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect.

The invention is, therefore, claimed in any of its forms or modifications within the proper scope of the appended claims appropriately interpreted by those skilled in the art.

1-21. (canceled)

22. An unmanned fixed wing vertical take-off and landing aircraft, comprising:
an elongated fuselage defining a longitudinal axis, the fuselage having a nose and a tail;
a pair of rearward swept fixed wings, each wing having a root end respectively attached at an opposite side of a middle portion of the fuselage; and
three pairs of independent thrust units, wherein at least a first pair of thrust units is positioned at the nose and tail of the fuselage and each of said fixed wings respectively comprises at least a pair of thrust units;
wherein the three pairs of independent thrust units are arranged at aerodynamically appropriate locations to enable vertical take-off and landing of the aircraft and to avoid a flight compromise when at least one of the three pairs of thrust units fails to operate.

23. The unmanned fixed wing vertical take-off and landing aircraft in accordance with claim 22, wherein the thrust units in each pair of said thrust units are arranged at diametrically opposite locations.

24. The unmanned fixed wing vertical take-off and landing aircraft in accordance with claim 22, wherein the three pairs of thrust units are arranged in a hexagonal configuration balanced about a center of gravity located in the middle portion of the fuselage.

25. The unmanned fixed wing vertical take-off and landing aircraft in accordance with claim 22, wherein a first plurality of at least three thrust units are mounted on the nose portion of the fuselage and each fixed wing respectively to form a forward V-shaped configuration and a second plurality of at least three thrust units are mounted on the tail portion of the fuselage and each fixed wing respectively to form a rearward V-shaped configuration.

26. The unmanned fixed wing vertical take-off and landing aircraft in accordance with claim 22, wherein one or more of the thrust units comprises rotors mounted on a rotary axle mechanism.

27. The unmanned fixed wing vertical take-off and landing aircraft in accordance with claim 26, wherein each fixed wing comprises a forwardly positioned thrust unit and a rearwardly positioned thrust unit, and wherein each thrust unit comprises oppositely arranged rotors mounted on corresponding rotary axle mechanisms that extend in upwardly and downwardly directions respectively.

28. The unmanned fixed wing vertical take-off and landing aircraft in accordance with claim 26, wherein the forwardly positioned thrust unit and the rearwardly positioned thrust unit are mounted on a mounting member extending across said fixed wing.

29. The unmanned fixed wing vertical take-off and landing aircraft in accordance with claim 26, wherein each fixed wing comprises a forwardly positioned thrust unit and a rearwardly positioned thrust unit such that at least the forwardly positioned thrust unit comprises said rotors mounted on the rotary axle mechanism, and the axle mechanism is arranged to tilt between the vertical direction and the horizontal direction.

30. The unmanned fixed wing vertical take-off and landing aircraft in accordance with claim 29, wherein the rearwardly positioned thrust unit comprises a rotors mounted on fixed rotary axle mechanism that does not undergo tilting.

31. The unmanned fixed wing vertical take-off and landing aircraft in accordance with claim 22, wherein the tail portion of the fuselage is connected to horizontal stabilizers and a vertical stabilizer such that the thrust unit located on the tail portion is mounted on the vertical stabilizer.

32. The unmanned fixed wing vertical take-off and landing aircraft in accordance with claim 31, wherein each of the fixed wings and the vertical and horizontal stabilizers comprises aircraft flight control surfaces, and wherein each control surface is divided into two independent sub-surfaces such that each sub-surface for any of the control surfaces is actuated by respective independently operable actuators for effecting independent angular movement about a hinge axis for each subsurface.

33. The unmanned fixed wing vertical take-off and landing aircraft in accordance with claim 32, further comprising an avionic control system comprising:
a first plurality of electro-mechanical devices to actuate the independently operable actuators for the first subsurface for each of the flight control surfaces; and
a second plurality of electro-mechanical devices to actuate the independently operable actuators for the second subsurface for each of the flight control surfaces.

34. The unmanned fixed wing vertical take-off and landing aircraft in accordance with claim 33, wherein the control system is arranged to effect actuated movement of one of the sub-surfaces for each of said control surfaces for counteracting the effect of failure of the other of said sub-surfaces for said each control surface in response to receiving input indicative of failure of the other of said sub-surfaces for said each control surface.

35. The unmanned fixed wing vertical take-off and landing aircraft in accordance with claim 32, wherein each fixed wing comprises at least one primary wing control surface to control aircraft movement along the roll axis, and wherein each primary wing control surface comprises two independently movable sub-surfaces actuated by respective independent primary wing control actuators.

36. The unmanned fixed wing vertical take-off and landing aircraft in accordance with claim 32, wherein each fixed wing further comprises at least one secondary wing control surface to control lift and drag of the aircraft, and wherein each secondary wing control surface comprises two independently movable sub-surfaces actuated by respective independent secondary wing control actuators.

37. The unmanned fixed wing vertical take-off and landing aircraft in accordance with claim 32, wherein each horizontal stabilizer comprises a primary horizontal stabilizer control surface to control aircraft movement about the pitch axis, and wherein each primary horizontal stabilizer control surface comprises two independently movable sub-surfaces actuated by respective independent primary horizontal stabilizer control actuators.

38. The unmanned fixed wing vertical take-off and landing aircraft in accordance with claim 32, wherein the vertical stabilizer comprises a primary vertical stabilizer control surface to control aircraft movement about the yaw axis, and wherein each primary vertical stabilizer control surface comprises two independently movable sub-surfaces actuated by respective independent primary horizontal stabilizer control actuators.

39. The unmanned fixed wing vertical take-off and landing aircraft in accordance with claim 22, wherein an aft section of the fuselage comprises a parachute deployment system to enable deployment of a parachute in a rearward and downward direction during substantial failure of the thrust units and/or control surfaces.

40. The unmanned fixed wing vertical take-off and landing aircraft in accordance with claim 22, wherein central section of the fuselage comprises a height with an internal volume defined by a top wall, side walls and a bottom wall such that height of the fuselage is substantially constant in the central section, and wherein the height gradually decreases from the central section towards the nose and tail respectively due to tapering of the floor and side walls towards the nose and tail respectively.

41. The unmanned fixed wing vertical take-off and landing aircraft in accordance with claim 39, wherein the parachute deployment system is arranged to deploy the parachute from an opening provided in the tapering floor section tapering towards the tail to allow the parachute to be unfurled out of a gap between the horizontal stabilizers of the fuselage, and wherein the parachute deployment system comprises an enclosure to enclose a parachute with a trigger mechanism coupled with the enclosure to trigger ejection of the parachute into deployed state, the trigger mechanism being operatively linked to a controller for controlling actuation of the trigger mechanism.
